(19) United States
(12) Patent Application Publication
(10) Pub. No.: US 2020/0296959 A1
(43) Pub. Date: Sep. 24, 2020

(54) DISINFECTION AND/OR STERILIZATION OF AGRICULTURAL CROPS

(71) Applicant: Andersen Products, Inc., Morrisville, NC (US)

(72) Inventors: Harold W. Andersen, Morrisville, NC (US); Elizabeth A. Krewson, Morrisville, NC (US); Albert E. May, Morrisville, NC (US)

(21) Appl. No.: 16/420,668

(22) Filed: May 23, 2019

Related U.S. Application Data
(60) Provisional application No. 62/821,651, filed on Mar. 21, 2019.

(51) Int. Cl. A01N 31/06; B65D 37/00; B65B 55/18

(52) U.S. Cl. CPC A01N 31/06; B65B 55/18; B65D 37/00

(57) ABSTRACT

Methods and devices for decontaminating agricultural material, which agricultural material may comprise carboxylic acids are disclosed. The methods involve contacting the agricultural material with a sufficient amount of ethylene oxide, at a temperature of between around 15 and 30° C., for a sufficient time so as to disinfect the products. Ethylene oxide sterilization conducted at these temperatures is sufficient to remove microbial contamination, but not sufficient to cause a sufficient quantity of carboxylic acid groups to react with ethylene oxide and form esters. Representative devices include sterilization bags, optionally stored in sterilization cabinets, sealed drums, and pallet-loaded disinfecting chambers, all adapted to safely purge ethylene oxide from the agricultural material after the sterilization. Representative agricultural materials include, but not limited to hemp and marijuana.

### FIELD OF THE INVENTION

The present invention generally relates to the disinfection and/or sterilization of agricultural crops, including but not limited to marijuana and hemp, which have been contaminated by mold or other microorganisms.

### BACKGROUND

Cannabinoids are molecules which bind to cannabinoid receptors in humans and other animals. Whereas endocannabinoids are produced within the human body, phytocannabinoids are produced by plants. While numerous cannabinoids have been identified, many share the chemical formula C₂₁H₃₀O₂. There are various plant sources for phytocannabinoids, including plants from the genus Cannabis L. Hemp is a common term for a variety of Cannabis Sativa L. species. Hemp is rich in cannabinoids, and its extracts are used as medicine.

Other common agricultural crops such as flax are known to produce cannabinoids such as cannabidiol (CBD), a well-known cannabinoid with a variety of uses, including pain management and inhibition of seizures, typically without causing adverse side effects.

Echinacea is another medicinal herb that contains cannabimimetic N-alkylamides, including N-acylethanolamines, such as anandamide, a cannabinoid of interest in many studies.

At least one species of rhododendron contains the cannabinoid cannabichromene (CBC), and New Zealand liverwort is believed to contain perrottetinenic acid, a cannabinoid similar in function to trans-Δ9-tetrahydrocannabinol (THC).

Herbal medicine using one or more of these agricultural products is a major industry. Two of the leading herbal medicines are hemp and cannabis, in their various forms.

In addition to contamination from ground water, pesticides, and the like, there are additional sources of contamination of these agricultural products. For example, mold and other microbes can grow on plants, which are not properly cultivated and harvested. Marijuana and hemp crops are often unusable due to these types of microbial contamination. By way of example, regulations in Colorado, Nevada and Canada require cannabis to have a total yeast and mold count (TYMC) of ≤10,000 colony forming units (CFUs) per gram. It is often difficult to meet these requirements, particularly given the presence of fungal spores, as opposed to living, growing mold.

Various methods have been attempted at decreasing and/or removing microbial contamination from these crops, though each approach has its own limitations.

One such method includes autoclave technology, which uses heat and pressure to kill the microbes, but cannot treat large batches, and uses moisture, which can actually increase mold risk. Further, the final product may experience decarboxylation, thus altering the chemical composition as well as changing the color, taste and smell. As an alternative, it is possible to use dry heat, but while this can be effective at reducing mold and yeast, it tends to ruin the agricultural product unless active agents are to be extracted from the treated product.

Alternatively, gamma radiation can reduce microbial growth. This approach does not tend to affect potency, is relatively fast, scalable and effective, tends not to result in terpene loss or decarboxylation, but uses ionizing radiation that can create new chemical compounds not present before, some of which can be cancer-causing. Further, the method relies on using a radioactive isotope to create the gamma rays, so is difficult to implement.

Hydrogen peroxide can reduce yeast and mold, but increases moisture, which can cause otherwise benign spores to germinate. Further, this approach only treats the plant surface, and also causes extreme oxidation, burning the cannabis and removing terpenes.

Microwave treatment can be used for small-scale operations, but is difficult to scale. Further, it tends to result in uneven heating, which burns the product, damages terpenes, where present, and greatly reduces product quality.

High pressure steam has been effectively used in other industries, as it is readily available, and is also scalable. However, this method adds moisture content to the agricultural products, which can introduce a further mold risk. For agricultural products including active carboxylic acids, such as tetrahydrocannabinol acid (THCA) and cannabadiol acid, the heat can also cause decarboxylation.

Supercritical extraction, using gases such as carbon dioxide, is effective at remediating mold-infected agricultural products. However, this approach extracts active compounds found in the agricultural product, forming a concentrate. Particularly with respect to marijuana, where there is a market premium for the “bud” or flower, over concentrates, this approach can result in a significant loss of profit.

It is also possible to disinfect agricultural products using various gases, such as ethylene oxide. These treatments are relatively inexpensive, and treat the entire agricultural product. Ethylene oxide has been used since the 1920s to decontaminate spices, and for use as a microbial pesticide.

While ethylene oxide can effectively eliminate microbial contamination on marijuana and hemp, traditional ethylene oxide sterilization processes operate at temperatures sufficiently high, for example, around 50-60° C., that the ethylene oxide will reduce the concentration of the active agent (i.e., CBD and/or THC) in these crops.

For example, at the elevated temperatures at which ethylene oxide sterilization is most commonly performed (i.e., temperatures reached during ethylene oxide sterilization are usually in the 50-60° C. range) active compounds in the agricultural products can be converted to undesired chemicals. For example, acids react with ethylene oxide to form glycol mono- and diesters, as exemplified below with acetic acid:

(CH₂CH₂)O+CH₃CO₂H→HOCH₂CH₂—O₂CCH₃(CH₂CH₂)O+(CH₃CO)₂O→CH₃CO₂CH₂CH₂O₂CCH₃.

With respect to marijuana, the active compound, THC, is formed as a result of decarboxylation of THCA. Decarboxylation reactions generally occur as follows:

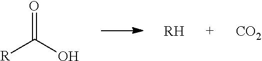

In this equation, the structure of “R” varies depending on the individual tetrahydrocannabinolic acid (THCA).

Decarboxylation only occurs on the free acid, not on esters such as glycol mono- or diesters. Accordingly, on information and belief, if ethylene oxide is reacted with marijuana or hemp at the elevated temperatures used in conventional ethylene oxide sterilization, the overall yield of active compounds such as THC and cannabidiol is significantly reduced.

Accordingly, there remains a need for a TYMC treatment method, particularly for materials which contain an active agent prone to thermal degradation, or unwanted chemical reactions when carried out at elevated temperatures, that is safe, reliable, efficient and scalable. Ideally, such a method would be applicable not only to small-scale operations, but can be implemented in order to streamline large scale operations. It would also be advantageous for such a method to decontaminate these crops without also damaging them, or lowering the concentration of active agents which can be derived from them. The present invention provides such a method.

### SUMMARY OF THE INVENTION

Methods for removing microbial contamination from agricultural products, in particular, agricultural products, which contain active agents that comprise carboxylic acid or amine groups, are disclosed.

The methods involve decontaminating these agricultural products using ethylene oxide, at temperatures which do not significantly damage the products or decrease the concentration of active agents (particularly those which include carboxylic acid or amine functional groups) obtainable from the products.

Liquid ethylene oxide (EO) converts to gas at 10.4° C. In its gaseous state, it becomes an effective decontaminant at a temperature of around 15-20° C. In the embodiments described herein, the decontamination temperature is between around 15 and 30° C., because this is a sufficient temperature for carrying out decontamination, but is not a sufficient temperature to convert carboxylic acid moieties present in active compounds in the agricultural products to esters, in a significant amount.

In one aspect of these methods, the agricultural products are marijuana or hemp, which include carboxylic acid-containing functional groups such as tetrahydrocannabinol-acid (THC-A) and cannabidiol acid (CBD-A). If the carboxylic acid groups are esterified with ethylene oxide under decontamination conditions, the corresponding ester compounds do not undergo thermal decarboxylation, which is required to obtain the active THC and/or CBD decarboxylation products. Minimizing esterification by performing the decontamination step at a relatively lower temperature overcomes the limitations associated with using relatively higher temperatures, where the amount of active agent in the agricultural products is reduced.

One example of an agricultural product which comprises amine groups that could otherwise react with ethylene oxide is tobacco. Decontaminating tobacco at relatively low temperatures can minimize reaction of the amine groups in nicotine with ethylene oxide, while still allowing the ethylene oxide to decontaminate tobacco crops which have microbial contamination.

In the methods described herein, agricultural products are in contact with a sufficient amount of ethylene oxide, for a sufficient period of time, and at a suitable temperature and pressure, to remove microbial contaminants, or decontaminate the products. Where the agricultural products comprise carboxylic acids, which might be esterified by ethylene oxide at elevated temperatures, a sufficient temperature is one which does not result in a significant amount of esterification.

A suitable temperature range is typically between around 15 and 39° C., more typically between around 20 and 30° C., still more typically between around 20 and 25° C. A suitable pressure is typically around atmospheric pressure, though typically ranges from about 0.2 to 2 ATM. However, in some embodiments, and, particularly, in relatively large devices, sub-atmospheric pressures can be used. Residence times are typically between around 3 and around 24 hours.

In some embodiments, additional time, such as 1 to 24 hours is used to aerate the material being processed.

After the agricultural product is contacted with a suitable amount of ethylene oxide, for a suitable time and at a suitable temperature and pressure, the remaining ethylene oxide can be removed, for example, by aeration, typically in the same chamber, and typically for a period of no less than 12 hours, more typically, no less than 24 hours.

After the crop is treated, it may be subjected to thermal decarboxylation, or to extraction, to isolate the precursors to the active agents, such as CBD-A and/or THC-A, and then thermal decarboxylation to form active agents such as CBD and/or THC.

In some embodiments, the methods also comprise the additional step(s) of extracting active agents from the agricultural products, and/or thermally decarboxylating active carboxylic acid-containing compounds present in the agricultural products, such as THC-A in marijuana and CBD-A in hemp.

Temperature ranges for the decarboxylation step are well known to those of skill in the art, but are typically between about 212° F. and about 300° F., more typically between about 230 and about 250° F. Typically, heating times are around 30-60 minutes, and it can be useful to stir the product periodically to ensure even heating.

Extraction methods typically include ethanol extraction, butane extraction, and supercritical carbon dioxide extraction. While supercritical carbon dioxide also tends to remove microbial contaminants, this type of extraction is typically only performed at modest scale, and it may not be possible to sell contaminated agricultural products to extraction companies. Accordingly, while the extraction company could remove microbial contaminants at small scale, a grower can decontaminate larger quantities of material, and sell the decontaminated material to extraction companies.

Devices for carrying out the methods are also disclosed. In one embodiment, the devices not only allow for decontamination, but also allow for thermally decarboxylating the agricultural products, and/or for extracting the precursors to the active agents, and then optionally subjecting them to thermal decarboxylation.

Any suitable container can be used which can safely apply a sufficient amount of ethylene oxide to the agricultural products, within the temperature and pressure ranges described herein.

Representative containers include gas-permeable bags, gas-impermeable bags, sealable drums, and pallet-loaded sterilizer units.

In one embodiment, the device used to carry out the methods includes the following components:
a) an ampoule containing ethylene oxide (in liquid form, and in the headspace of the ampoule, also in gas form), which ampule is adapted such that it can be opened or activated while present in a sealed plastic bag using minimal handling, which, in one embodiment, is an Anprolene® ampule, as sold by Andersen Products (Haw River, N.C.);
b) a plastic sterilization bag, such as a gas-permeable or gas-impermeable bag, with an open end and a closed end, of a sufficient size to encompass the agricultural product to be decontaminated, which in one embodiment is a polyethylene bag, such as low density polyethylene (LDPE) bag; and
c) a system for sealing the agricultural product in the bag, while inhibiting release of ethylene oxide to be released from the ampule.

This system includes a relatively small number of components for performing the decontamination, and is based on the bag being present in a temperature-controlled space such that the temperature is within the desired range. While this system allows for decontamination of the agricultural products within the bag, it does not include components for purging residual ethylene oxide.

While it may be acceptable, in certain embodiments, to simply re-open the bag and allow residual ethylene oxide to vent (such as where the bag can be opened in a vent hood), in other embodiments, it may be preferable to include additional components which allow for venting the bag before it is re-opened. For example, one optional additional component, such as an Anprolene® Purge Probe is inserted into the ventilation chamber for disposing of EO that diffuses from the surface of the sterilization bag, as sold by Andersen Products (Haw River, N.C.).

In these embodiments, the bag can optionally but preferably be present in a ventilated, negative pressure container, such as a sterilizer cabinet. The sterilizer cabinet typically includes an exhaust line that allows EO to purge to the atmosphere.

In some aspects of this embodiment, during the process, the sterilization cabinet can act as an enclosed vent hood, maintaining a continuous airflow around the sterilization bag, but not within the sterilization bag. This can be particularly important where the bag is formed of a permeable material, as ethylene oxide may permeate through the bag, and into the sterilization cabinet, where an exhaust line can pass the permeating ethylene oxide through or past an emission system. For example, ethylene oxide can be inactivated/neutralized using acidic or basic conditions, which, in one embodiment, involves passing the air flow through a column comprising a polymeric resin, such as an Amberlyst catalyst, or Dowex-50, where the polymer in the resin comprises sulfonic acid groups.

In one embodiment, the device is a sealable drum, which can effectively process agricultural materials with ethylene oxide without allowing the ethylene oxide to leak out during the decontamination process. In some embodiments, the drum includes a cover which includes a mechanism that allows the agricultural material to be aerated, and the ethylene oxide to be purged, after the decontamination process is complete. While 55 gallon drums are a standard size, other sizes can be used. This methods allows for an ampoule to then be broken to release the ethylene oxide, the lid can be placed on the drum, and the drum stored in a manner in which the temperature is maintained between about 15 and about 30° C. for a suitable amount of time to disinfect the material. The disinfection time is typically longer for a 55 gallon drum than for a smaller bag, resulting in decontamination cycle times from 1 to 5 days, rather than, for example, about 4 to about 24 hours for the smaller bag.

If desired, a large gas-permeable or impermeable bag with an open end and a closed end can be placed inside the drum, and the agricultural material and an ampoule of ethylene oxide placed in the bag, one end of a tube placed in the open end, the bag sealed around the tube (optionally using a purge probe), and the tube passed through an opening in the drum lid. The other end of the tube can be attached to a valve, in a shut position to avoid having ethylene oxide leak out of the tube.

After the agricultural material has been decontaminated, excess ethylene oxide can be removed from the agricultural material. In some embodiments, where there is no tube, the drum can be opened and the ethylene oxide allowed to vent to atmosphere. Where there is a tube, and the tube is attached to a valve, the valve can be opened, and a gas such as air or nitrogen can be introduced (i.e., the agricultural material can be aerated), then a vacuum can be applied and the gas purged from the drum and, ideally, passed across a chemical, such as a Dowex® resin, that neutralizes the ethylene oxide. Optionally, two or more cycles of aeration and purging can take place, until the ethylene oxide is no longer present at concentrations which might be deemed harmful.

In another embodiment, pallet-loaded sterilizers are used, for example, Sterigenics® ethylene oxide sterilizers. Such sterilizers are well known to those of skill in the art, and typically include a range of control system options, including temperature, pressure, hold times, and the like, which allow them to be used at the right temperature, pressure, and hold times to decontaminate large quantities of agricultural products.

The present invention will be better described with reference to the following Detailed Description.

### BRIEF DESCRIPTION OF THE FIGURES

FIG. 1 is a schematic illustration of a sterilization chamber which can be used with sterilization bags (both gas-permeable and gas-impermeable bags).

FIG. 2 is a schematic illustration of a gas-permeable bag, equipped with a tube (known as a purge probe) that extends out of the bag, and which is sealed within the bag in a manner which minimizes leakage.

FIG. 3A is a photograph of a pallet-loaded sterilization chamber, with the door open, thus showing the inside of the chamber.

FIG. 3B is a photograph of a pallet-loaded sterilization chamber, showing the back of the outside of the chamber, including a red ethylene oxide cylinder, piping into and out of the chamber, an abatement column for neutralizing unreacted ethylene oxide, and a vacuum line for withdrawing gases from the chamber.

FIGS. 4 and 5 are charts showing the effectiveness of sterilization performed in a 55 gallon drum under 17.6 grams of ethylene oxide over a period of time. FIG. 4 shows the empty decontamination barrel EO concentration gas chromatography (GC) data, in terms of EO concentration (mg/L) versus cycle time (hours). FIG. 5 shows decontamination barrel paper load ethylene concentration data, in terms of EO concentration (mg/L) versus cycle time (hours).

FIG. 6 is a chart showing EO lethality in terms of concentration (mg/liter) and lethal rate (logs/min) over time (min).

### DETAILED DESCRIPTION

Methods and devices for decontaminating agricultural products are disclosed in more detail below.

All that is required to successfully decontaminate agricultural products without adversely affecting any carboxylic acid-containing and/or amine-containing molecules included in these products is a container, either rigid or flexible, for holding the agricultural products, a source of ethylene oxide within the container, and the ability to control the temperature between about 15 and about 30° C. for a sufficient time to decontaminate the products. However, in certain embodiments discussed in more detail below, the devices also include additional components, for example, components to automate and/or control the decontamination process, components to withdraw unreacted ethylene oxide from the container after the decontamination process is complete, and/or components for neutralizing excess unreacted ethylene oxide after the decontamination process is complete.

Individual representative devices, various components of certain embodiments of these devices, and methods for using them to decontaminate agricultural products, are described in more below:

### I. Sterilization Bags and Methods of Usage

In some embodiments, a device for sterilizing agricultural products includes a relatively small number of components for performing the decontamination, and is based on a sterilization bag (made of gas-permeable or gas-impermeable plastic) being present in a temperature-controlled space such that the temperature is within the desired range. While this system allows for decontamination of the agricultural products within the bag, it does not include components for purging residual ethylene oxide.

While it may be acceptable, in certain embodiments, to simply re-open the bag and allow residual ethylene oxide to vent (such as where the bag can be opened in a vent hood), in other embodiments, it may be preferable to include additional components which allow for venting the bag before it is re-opened. For example, one optional additional component is a ventilation chamber for disposing of EO that diffuses from the surface of the sterilization bag.

In these embodiments, the bag can optionally but preferably be present in a sealed container, such as a sterilizer cabinet.

In said embodiment, gas-permeable and/or gas-impermeable bags are stored in a sterilization chamber during the decontamination step. The sterilization chamber can include components for controlling the temperature within the chamber, and, thus, within the sterilization bag.

In one aspect of this embodiment, the bag includes a “sealable opening” through which one end of a tube or a purge probe can be inserted. The other end of the tube can be attached to a valve, which allows for the entry of a gas, such as air and/or allows for gas within the bag to be purged. Any unreacted ethylene oxide can thus be purged from the bag through one or more cycles of “aeration” (i.e., where a gas is inserted into the bag, where it can mix with unreacted ethylene oxide) and/or purging (where gas is removed from the bag).

The gas-permeable and impermeable bags include a closed end and an open end. In some embodiments, the gas-permeable and/or gas-impermeable bags include a purge probe which can be placed in the open end.

The purge probe has an opening adapted to receive one end of a tube, in such a manner that there is no leakage between the outside of the tube and the inside of the purge probe. The purge probe is also adapted to be inserted inside the open end of the bag, and, when a portion of the open end of the bag is placed around the outside of the purge probe and is sealed with a strap, to create a tight leak-proof seal between the bag and the outside of the purge probe The seal between the purge probe and the bag can be created, for example, using a strap with a Velcro® closure, sold by Andersen Products (Haw River, N.C.).

The other end of the tube can be connected to a valve, which, when shut, inhibits the ability of ethylene oxide to escape. When open, the valve can either allow a gas, such as air or nitrogen, to be placed inside of the bag, or for gases inside the bag to be safely evacuated. In some embodiments, when the gases are safely evacuated, they are either safely vented to the atmosphere, where they can be diluted, or passed through a neutralizing agent so the ethylene oxide can be destroyed.

In this manner, agricultural materials to be decontaminated, and an ampoule of ethylene oxide, can be placed within the bag, the bag can be safely sealed from leakage, the ampoule can be opened to release the ethylene oxide within the bag, the bag can be kept at a temperature between about 15 and about 30° C. for a sufficient period of time to allow decontamination to occur, and then any unreacted ethylene oxide can be allowed to vent out of the bag, rendering the agricultural products both safe to handle and decontaminated from microbial contaminants.

The sterilizer cabinet typically includes an opening through which a tube can be connected to a bag within the sterilizer cabinet, where the tube is connected to a source of inert gas, such as nitrogen, which can purge the bag to remove residual EO after the process is completed. The tube either allows EO to purge to the atmosphere, for example, if the sterilizer cabinet is stored outside, or passes the residual EO, if any, through a strongly acidic or basic material to react and neutralize the EO.

Unreacted ethylene oxide can thus be safely expelled by either venting it into the environment, where it can be diluted to safe levels, or by contacting it with a neutralizing agent, such as an acid or a base, which neutralizes the ethylene oxide. When the decontamination is performed at a relatively small scale, one effective way to neutralize the ethylene oxide is to pass it over a strongly acidic cation exchange resin, for example, Dowex® acids, such as a graduated Dowex® resin.

In some aspects of this embodiment, during the process, the sterilization cabinet can act as an enclosed vent hood, maintaining a continuous airflow around the sterilization bag, but not within the sterilization bag. This can be particularly important where the bag is formed of a permeable material, as ethylene oxide may permeate through the bag, and into the sterilization cabinet, where a continuous air flow can pass the permeating ethylene oxide through or past a compound which neutralizes/inactivates the permeating ethylene oxide, which compound can be present, for example, in a tube which runs to the outside of the cabinet. For example, ethylene oxide can be inactivated/neutralized using acidic or basic conditions, which, in one embodiment, involves passing the air flow through a column comprising a polymeric resin, such as an Amberlyst catalyst, or Dowex-50, where the polymer in the resin comprises sulfonic acid groups.

At larger scales, packed bed scrubbers can be used to inactivate/neutralize permeating ethylene oxide, for example, using solids such as Dowex® acids, such as a graduated Dowex® resin, or liquids such as sulfuric acid, sodium hydroxide, and ammonia solutions.

Gas-permeable and impermeable bags are typically sized to hold up to around five pounds of agricultural products to be decontaminated, though larger bag sizes are within the scope of the invention and are sold by Andersen Products (Haw River, N.C.).

The sterilization chamber can optionally include one or more of the following: a visual display which shows decontamination parameters, such as remaining cycle time, temperature, aeration time, purge time, and the like, keypad buttons for entering desired decontamination parameters and for commencing cycles, a door lock to help minimize the chance of the door inadvertently being opened and leaking ethylene oxide into the environment, a cooling fan, a power cord socket and switch, and an emergency exhaust port, for example, to safely vent ethylene oxide to the environment.

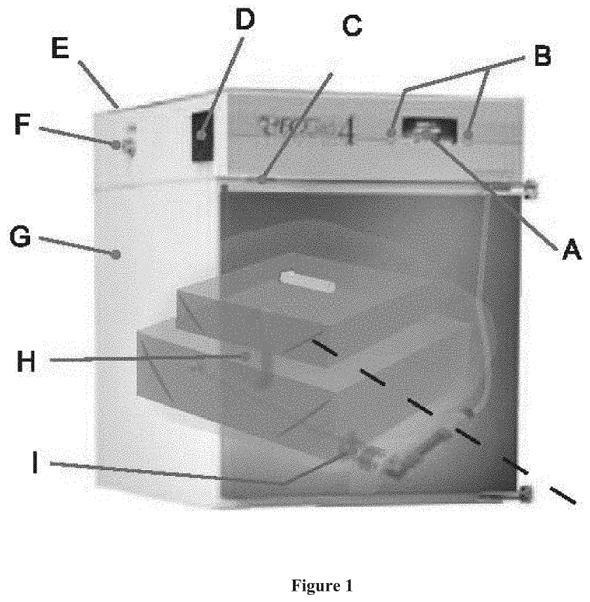

A representative device is shown in FIG. 1. As shown in FIG. 1, the sterilization cabinet includes an operations display (A), keypad buttons (B), a door lock (C), a cooling fan guard, ideally comprising a removable filter (D), a power cord socket and switch (E), an emergency exhaust port (F), a cabinet (G), a wrapped sterilization load (H), and a purge probe (I). An EO ampule (J) is present inside the wrapped sterilization load, though not shown in FIG. 1.

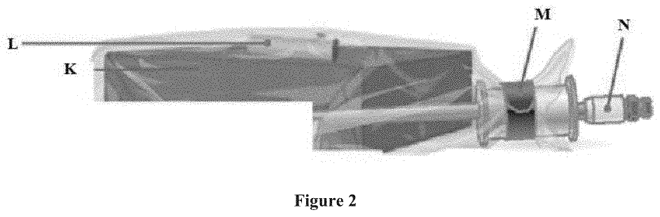

The wrapped sterilization load (H) is more clearly shown in FIG. 2. As shown in FIG. 2, the wrapped sterilization load includes a gas sterilization bag (K), a “Humidichip” and Tube (L), a Velcro® strap with a buckle (M), and a quick release connector (N).

Optional Additional Components: All Provided by Andersen Products (Haw River. N.C.)

AN1004 Gas Refill Kits contain replacement gas cartridges, liner bags, Dosimeter®s, and Humidichip®s in a convenient storage/dispenser box. These components are discussed in more detail below.

AN1080 Steritest® Biological Indicators reliably verify that sufficient concentration of EO killed one million B. atrophaeus spores, the spore most resistant to EO gas. Biological indicators are the best and most acceptable method to ensure sterility after a cycle.

AN1087 Dosimeter Chemical Integrators present visual assurance that proper time, temperature, and ethylene oxide gas concentration were reached during the sterilization cycle.

AN85 Exposure Indicator Strips change color to provide immediate assurance of EOGas exposure at the end of the sterilization cycle. They include convenient self-stick backing that adheres to conventional paper or cloth wrapping.

AN1071Humidichip® & AN1072 Humiditube® These pre-moistened chips placed inside the tube ensure that relative humidity requirements are met during the sterilization cycle.

Humidity is very important to the ethylene oxide gas sterilization process. The relative humidity must be at least 35% in the room or atmosphere where sterilization takes place. Active spores that might be on the agricultural products may become desiccated and more resistant to ethylene oxide gas if the relative humidity is below 35%.

In some embodiments, additional components are used to monitor and/or stabilize humidity levels inside the bag. In one aspect of this embodiment, an AN-1071 Humidichip® RH Stabilizer (Andersen Products, Haw River, N.C.) is used. This stabilizer is designed to ensure adequate relative humidity during the sterilization cycle. The Humidichip® is a single-use, pre-moistened 2″×2″ pad which releases suitable quantities (for example, up to 4 grams) of water vapor.

In some aspects, a Humidichip® is employed inside of a tube, such as a Humiditube™ (Andersen Products). The tube guarantees that there is free air circulation around the Humidichip®, thereby ensuring that the chip performs at maximum efficiency.

In other aspects, components are added to verify, for example, colorimetrically, that ethylene oxide was present in the sterilization bag. For example, an AN1087 Dosimeter® (Andersen Products, Haw River, N.C.) provides a visual indication at the end of a cycle that adequate time, temperature, and EO concentration for sterilization have been met. The AN1087 Dosimeter is designed to integrate the effects of time, temperature, and the concentration of ethylene oxide on the sterilization load. The dosimeter includes a yellow material in an indicator column which turns blue in proportion to the dose of sterilizing gas, thus providing immediate graphic evidence that the conditions necessary for sterilization of properly prepared materials have or have not been met.

In other aspects, the sterilization process also comprises one or more sterility indicators, such as biological indicators, such as integrators, and/or chemical exposure indicators are used.

In one embodiment, where gas-permeable or gas-impermeable bags are used, the batch size for decontamination is between around one ounce to around five or ten pounds of product. In other embodiments, larger devices can process hundreds of pounds of agricultural products per cycle. For example, weight ranges for the agricultural product to be decontaminated with ethylene oxide inside a sterilizer bag are typically up to around 5 pounds although greater weights may be processed in large commercial chambers adapted for this purpose.

In one embodiment, a ventilation system is used to maintain a “modest sub-atmospheric pressure” in the cabinet. Air drawn through the cabinet can be continuously evacuated to the outside, for example, using an exhaust hose. This type of process is referred to herein as active aeration.

Typically, the cabinet does not use supplemental heaters or coolers, and simply operates at the temperature of the room where it is installed. For effective processing the temperature in the sterilization room must be maintained above 15° C., but below around 30° C., throughout the course of the cycle.

In one embodiment, after agricultural products to be decontaminated, and an ampule of ethylene oxide, are added to the bag, a “purge probe” is inserted into the open end of the bag and the mouth of the bag is then sealed.

In one aspect of this embodiment, the bag is sealed by drawing a Velcro strap firmly around the neck of the probe. In other aspects of this embodiment, elastic devices, such as rubber bands, or pipe clamps, can be used to seal the bag around the purge probe.

The bag and Purge Probe are then placed inside the sterilizer cabinet and the Purge Probe is connected to the cabinet by means of a quick disconnect fitting and vacuum line. At the start of the cycle air is removed from the sterilization bag via the Purge Probe. The ampoule is then manually broken, a process referred to herein as “ampoule activation,” and the sterilization process begins. The liquid ethylene oxide in the ampoule converts to gas and fills the Gas Release Bag. Ethylene oxide diffuses out of the gas release bag into the sterilization bag, which sterilizes the products inside.

During the process the sterilization cabinet acts as an enclosed vent hood, maintaining a continuous airflow around the sterilization bag. The ventilation system maintains a modest sub-atmospheric pressure in the cabinet. Air drawn through the cabinet is continuously evacuated to the outside by means of an exhaust hose. The cabinet does not use supplemental heaters and operates at the temperature of the room where it is installed. For effective processing the temperature in the sterilization room or outside environment must be maintained above 15° C., and below 39° C., preferably below 30° C., throughout the course of the cycle.

At the end of the cycle the purge probe removes EO from the sterilization bag and initiates a purge process that flushes clean air through the bag for a suitable amount of time to reduce the amount of residual EO, which is typically around two hours, though longer times can be used.

In one embodiment, at the end of this purge process, the cabinet can enter an “aeration mode,” during which it continues to flush the sterilization bag with clean air, and, optionally but preferably, keeps track of elapsed aeration time.

Optionally, the device also comprises one or more sterility indicators, such as biological indicators and/or chemical exposure indicators.

Due to safety hazards associated with the use of ethylene oxide, it is preferable that items, such as the agricultural products, are not removed from the sterilization bag (and cabinet) until they are fully aerated and safe to handle.

In some embodiments, process controls can be used to verify that the agricultural products are safe to handle. These typically include one or more chemical indicators, Dosimiter™ chemical integrators, and biological indicators, which are designed for use in ethylene oxide sterilization units.

Representative chemical indicators include the AN85® Exposure Indicator Strip, which allows operators to quickly identify which loads have been contacted with sufficient ethylene oxide pressure and, optionally, for a sufficient period of time, though these do not measure the presence or absence of biological contaminants, such as microbial contaminants.

The indicator strips change from yellow to blue when ethylene oxide gas has come into contact with the strip during the sterilization process. These indicators react to exposure to ethylene oxide though do not confirm sterility.

Dosimeter™ Chemical Integrators, such as the AN87® Dosimeter, can confirm that the conditions for sterilization have been met, and provides an immediate feedback on the success of a sterilization cycle. A “passing” AN87® Dosimeter indicates that the sufficient amount of ethylene oxide gas concentration, time, and temperature have been exposed to the dosimeter, which was placed inside the load of contents to be sterilized.

Representative biological indicators include those which are compatible with standard 10⁶ Bacillus atrophaeus indicators that have been cleared for use with EO processes. Biological indicators typically require up to 48 hours of incubation after having been processed with a sterilization method in order to confirm results.

Once the sterilization process has been performed, and after optional aeration and/or verification (for example, using one or more chemical indicators, Dosimiter™ chemical integrators, and biological indicators) has been conducted, it can be important to abate emission of residual ethylene oxide.

In one embodiment, the ampule (such as the Andersen Anprolene® ampule) includes a relatively small amount of ethylene oxide, for example, less than about 20 grams of ethylene oxide, per cycle. At the end of a sterilization cycle, after optional aeration, residual EO can be released into an exhaust stream through the purge probe, for example, via a tube or hose, and to a neutralizing agent. Because a relatively small concentration of EO can be used, relatively simple technology can be used to abate the gas. In one embodiment, the gas is abated using a dry cationic resin bed that chemically converts the ethylene oxide into an inert polymer. The only component of this system with moving parts is the exhaust blower. Since the exhaust blower pulls the exhaust through the resin bed, only “clean” air reaches the blower.

In one aspect of this embodiment, the abator (sold by Andersen Products Haw River, N.C.) comprises a disposable resin cartridge, which is effective for a predetermined number of sterilization cycles before it needs to be replaced.

### Methods Involving Permeable Sterilization Bags

As described herein, Type 2—ethylene oxide cartridge based systems use permeable flexible sterilization bags. These general steps should be followed when using a Type 2 system:

a) Agricultural products to be sterilized can be packaged in appropriate sterile barrier packaging. The packaged devices may be preconditioned for a designated time.

b) Agricultural products to be sterilized can be placed into permeable flexible sterilization bags.

c) A unit dose ethylene oxide cartridge that has been validated for the load/flexible bag combination is placed in the flexible sterilization bag.

d) In addition to the ethylene oxide cartridge, the flexible sterilization bag may also contain a humidity release device to maintain relative humidity, ideally at greater than or equal to 30%.

e) An intrinsically safe wireless data-logger for temperature and relative humidity can optionally be placed inside the flexible sterilization bag.

f) The flexible sterilization bag is optionally hermetically vacuum-sealed using an external sealer and placed in a sterilization/aeration cabinet. The flexible sterilization bags can then be transferred to the sterilization/aeration cabinet within a defined time period, which is usually 1 to 24 hours. The sterilization/aeration cabinet operates under sub-atmospheric pressure during the duration of the cycle and maintains a constant airflow.

g) The typical sterilization/aeration cabinet temperature range is between about 15° C. and about 30° C.

h) During decontamination and aeration, the ethylene oxide gas is absorbed into the agricultural material and also diffuses through the flexible sterilization bag into the sterilization/aeration cabinet. Ethylene oxide is continuously exhausted from the sterilization/aeration cabinet during the sterilization/aeration cycle.

i) At the end of the sterilization/aeration cycle, the flexible sterilization bag is manually slit open while still in the sterilization/aeration cabinet.

j) After completion of aeration, the agricultural products are removed from the flexible sterilization bag, and the used flexible sterilization bags and empty ethylene oxide cartridge and any internal controls are discarded.

Gas concentrations will range from 600 mg/L down to 50 mg/L. Cycle times for this process will range from 6 to 48 hours depending upon the gas concentration.

### Methods Involving Impermeable Sterilization Bags

As described herein, Type 3—EO cartridge based systems use effectively impermeable flexible sterilization bags. These general steps should be followed when using a Type 3 system:

a) Agricultural products to be sterilized are packaged in appropriate sterile barrier packaging. The packaged devices may be preconditioned for a designated time.

b) Individually packaged agricultural products in the corresponding sterile barrier system can be placed in an effectively impermeable flexible sterilization bag.

c) A unit dose ethylene oxide cartridge that has been validated for the load/bag combination is placed in the flexible sterilization bag.

d) In addition to the ethylene oxide cartridge, the flexible sterilization bag may also contain a humidity release device to maintain relative humidity at greater than about 30%. Each flexible sterilization bag can also contain internal controls, such as a biological indicator in a PCD and/or a chemical integrator for ethylene oxide.

e) The flexible sterilization bag is sealed around a purge device, and the flexible sterilization bag with the purge device attached is placed in a sterilization/aeration cabinet. The sterilization/aeration cabinet operates under sub-atmospheric pressure during the duration of the cycle and maintains a constant airflow.

In one embodiment, this airflow is appropriately monitored and measured to assure the validated airflow requirements are being met.

f) The typical sterilization/aeration cabinet temperature range is 15° C.-30° C.

g) At the start of the cycle the purge device removes excess air and draws a specified vacuum on the flexible sterilization bag. The vacuum specification is determined in the validation process.

h) The ethylene oxide cartridge is activated per manufacturer's instructions through the bag, releasing ethylene oxide inside the flexible sterilization bag.

i) During sterilization, the ethylene oxide from the activated cartridge fills the flexible sterilization bag. The ethylene oxide remains in the bag for the duration of the sterilization cycle.

j) At the end of the sterilization cycle, the purge system removes the ethylene oxide from the flexible sterilization bag. The purge system continues to flush the bag with fresh air, aerating the load.

NOTE: The bag may be flushed with nitrogen, which may be, for example, medical grade nitrogen, or air, for example, fresh filtered air.

k) The flexible sterilization bag remains in the sterilization/aeration cabinet for the duration of the aeration cycle.

l) After completion of aeration, the sterile, packaged devices and any monitoring devices (e.g., temperature controls, relative humidity indicators, ethylene oxide gas controls, data loggers, biological indicators, chemical integrators) are removed from the flexible sterilization bag, and the used flexible sterilization bag and empty EO cartridge are discarded.

Gas concentrations will range from 600 mg/L down to 50 mg/L. Cycle times for this process will range from 3 to 48 hours depending upon the gas concentration.

### II. Drum Sterilization Units and Methods of Using Same

In one embodiment, the device is a sealable drum, which can effectively store agricultural materials and ethylene oxide without allowing the ethylene oxide to leak out during the decontamination process. In some embodiments, the drum includes a cover, which has an opening to receive a tube, much like the tube in the sealed gas-permeable or impermeable bags, so as to allow the agricultural material to be aerated, and the ethylene oxide to be purged, after the decontamination process is complete. While 55-gallon drums are a standard size, other sizes can be used.

If desired, a large gas-permeable or impermeable bag with an open end and a closed end can be placed inside the drum, and the agricultural material and an ampoule of ethylene oxide placed in the bag, one end of a tube placed in the open end, the bag sealed around the tube (optionally using a purge probe), and the tube passed through an opening in the drum lid. The other end of the tube can be attached to a valve, in a shut position to avoid having ethylene oxide leak out of the tube. The ampoule can then be broken (or “activated”) to release the ethylene oxide, the lid can be placed on the drum, and the drum stored in a manner in which the temperature is maintained between about 15 and about 30° C. for a suitable amount of time to disinfect the material. The disinfection time is typically longer for a 55-gallon drum than for a smaller bag, resulting in decontamination cycle times from 1 to 5 days, rather than, for example, about 4 to about 24 hours for the smaller bag.

After the agricultural material has been decontaminated, excess ethylene oxide can be removed from the agricultural material. In some embodiments, where there is no tube, the drum can be opened and the ethylene oxide allowed to vent into atmosphere. Where there is a tube, and the tube is attached to a valve, the valve can be opened, and a gas such as air or nitrogen can be introduced (i.e., the agricultural material can be aerated), then a vacuum can be applied and the gas purged from the drum and, ideally, passed across a chemical, such as a Dowex® resin, that neutralizes the ethylene oxide. Optionally, two or more cycles of aeration and purging can take place, until the ethylene oxide is no longer present at concentrations which might be deemed harmful.

In some embodiments, the decontamination methods involving the use of a drum involve using ethylene oxide at a concentration of <100 mg/L (i.e., less than about 22 grams of EO per drum). In a 55-gallon drum, roughly 275 pounds of agricultural products can be treated. The actual weight of agricultural products that can be treated will vary upon the nature, condition and packaging of the product.

### III. Pallet Loaded Sterilization Units and Methods of Using Same

In another embodiment, pallet-loaded sterilizers are used. Commercial ethylene oxide pallet-loaded sterilizers are commercially available, for example, from Sterigenics®.

As with the Andersen Products sterilization units described herein, pallet-loaded ethylene oxide sterilizers can also include control and monitoring systems. Such systems can allow for process control through a range of control system options, including temperature, pressure, hold times, and the like. Information on each batch can be saved.

In some embodiments, pallet-loaded sterilizers include automatic pallet transfer systems, where pallets are loaded automatically into the sterilizer. For example, Sterigenics® offers a pneumatically operated automated system for moving products, in this case, agricultural products, through the sterilization process. Pallets are accurately positioned within the chamber to maximize throughput and efficacy.

The doors of these sterilization units are ideally sealed using gaskets, which are resistant to degradation, by ethylene oxide. Such gaskets can remain leak tight even other parts of the system (for example, parts which allow for ethylene oxide to be purged from the system) fail.

In order to maintain the temperature within the desired range, the sterilization units ideally include heating and cooling systems.

Ethylene oxide (EO) is usually supplied as a liquid in pressurized containers, and is typically added to the sterilization units in a manner which ensures that liquid EO does not enter the sterilization area. For example, EO can be heated using a heating means, such as steam or hot water, which provides temperature control and flow regulation.

As with embodiments where a sterilization bag is used, sterilization in a pallet-loaded chamber also benefits from EO abatement after the decontamination process is complete. Catalytic abatement systems, including those using solid acid catalysts, such as Dowex® resins, can be provided to process all of the EO used in the sterilization and degassing process including from the chamber, piping, and vacuum pump water system.

The systems ideally also include vacuum systems for purging EO out of the chamber when the decontamination process is complete. These vacuum systems can include, for example, water ring pumps, or multi-booster dry pump systems for pulling extreme vacuums.

As with the sterilization bags, additional components can be used to assure that decontamination has been completed. For example, multi-parameter indicators, often referred to as dosimeters, can verify the temperature, time, and amount of EO in each batch.

In some embodiments, the chambers include one or more of the following: ventilated enclosures, automatic doors with locking mechanisms, and temperature and/or humidity controlled air-handling systems.

In some embodiments, the chambers also include means for homogenizing the EO and other gases inside the chamber, to assist with aeration and purging steps. Gas recirculation systems can help ensure fast and efficient mixing of the chamber environment. Chamber internal volumes for commercially available EO sterilization units typically range from about 2 to about 90 cubic meters.

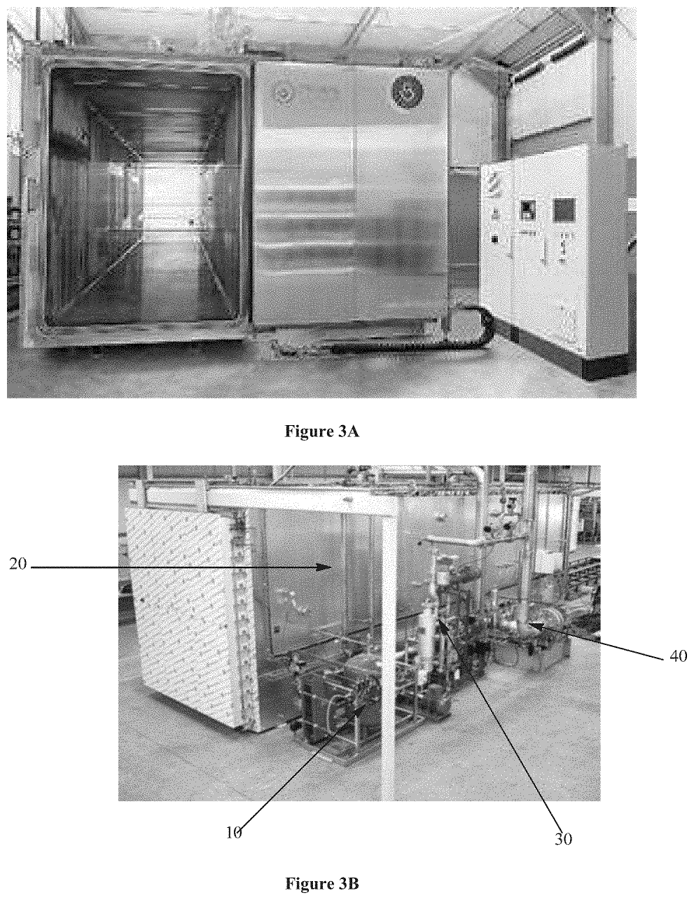

Representative pallet-loaded EO sterilization chambers are shown in FIGS. 3A and 3B. FIG. 3A is a photograph of a pallet-loaded sterilization chamber, showing the inside of the chamber. FIG. 3B is a photograph of a pallet-loaded sterilization chamber, showing the back of the outside of the chamber, including a red ethylene oxide cylinder (10), piping into and out of the chamber (20), an abatement column (30) for neutralizing unreacted ethylene oxide, and a vacuum line (40) for withdrawing gases from the chamber.

The present invention will be better understood with reference to the following non-limiting examples.

### Example 1: Representative Sterilization Protocol Using Andersen Products EOGas 4 Sterilizer

Andersen Products (Haw River, N.C.) sells a commercial sterilizer, which can be used to decontaminate agricultural products at a modest scale, i.e., up to around 5 pounds per batch. While particular aspects of this commercial sterilizer are described, certain parameters can also be applied to other ethylene oxide sterilization devices as well.

The active ingredient is ethylene oxide (EO). EO is a powerful anti-microbial agent; it can also be dangerous if not handled correctly.

The sterilizer can be operated at different sterilization cycles, longer at lower temperatures, and shorter at temperatures up to around 30° C. (86° F.). EO gas requires more time to properly sterilize when operating at lower temperatures.

The EOGas 4 sterilizer can be run at room temperature sterilization cycles at around 30° C. for a 12 hour cycle and a 24 hour cycle. When these relatively low temperatures are used, the bag ventilation time is increased, relative to when higher temperatures are used, up to 24 hours.

It can be important to maintain a relative humidity above 35%. The AN1071 Humldichip and AN1072 Humiditube (all which are provided by Andersen Products, Haw River, N.C.) ensure that humidity requirements for EOGas 4 sterilization are maintained in the sterilization bag.

The AN1087 Dosimeter® provides an immediate indication at the end of a cycle that adequate time, temperature, and EO concentration for sterilization have been met.

As shown in FIG. 1, the sterilizer includes the following components:

A: Operations Display

B: Keypad Buttons

C: Door Lock

D: Cooling Fan Guard with Removable Filter

E: Power Cord Socket and Switch (on rear)

F: Emergency Exhaust Port

G: Sturdy Powder Coated Steel Cabinet

H: Wrapped Sterilization Load

I: Purge Probe

As shown in FIG. 2, the sterilization bag includes the following components:

J: EOGas 4 Cartridge

K: Gas Sterilization Bag

L: Humidichip and Tube

M: Black Velcro Strap with Buckle

N: Quick Release Connector

In use, once biological material is placed in the sterilization bag, along with an ampoule of EO, tubing can be inserted into a port, and the bag can be essentially sealed, other than by allowing EO to leave via the tubing after the sterilization is complete and the bag is purged and/or aerated.

Once the bag is sealed, the ampoule can be broken, or “activated”, to release EO within the bag, such that it can come into contact with the agricultural material. The bag can then be placed in the sterilization cabinet, and stored for a suitable amount of time, at a suitable temperature.

### Preparing for Sterilization

Environmental Considerations

Ethylene oxide FACTS: At sea level, ethylene oxide is a liquid below 51° F. Above 51° F., ethylene oxide begins to boil and converts into a gas. Ethylene oxide does not become an effective sterilant until it is 68° F. Even though the EOGas 4 cabinet is heated, make sure that the room where your EOGas sterilizer is installed remains above 68° F.

Humidity

Humidity is very important to the EOGas process. Relative Humidity (RH) must be at least 35% in the room where item preparation and sterilization take place. Spores that might be on the agricultural materials may become desiccated and more resistant to EO if the RH is below 35%.

Process for Pre-Humidification Using a Liner Bag

Make sure the sterilizer is switched on.

Prepare the items in the load for sterilization.

Place the prepared items along with a Humidichip inside a sterilization liner bag. Using the Velcro strap, securely close the neck of the bag around the purge bobbin. It is not necessary to attach the purge probe to the purge tube at this time.

Place the bag in the sterilizer for 2 hours, then remove the bag from the sterilizer for an additional 2 hours to allow for cooling. Do not activate the cartridge at a temperature greater than 30° C.

After the 2 hours of cooling, the bag may be placed in the sterilizer and the cycle started normally.

Pre-cleaning

These general steps should be followed:

Wash and presoak the agricultural material, if appropriate, then dry the material.

The biological material can be dried, for example, using towel drying or air drying. Heat or hot air should not be used to dry agricultural material prior to sterilizing it with EOGas because it may dehydrate or desiccate bacteria spores making them more resistant to the ethylene oxide gas.

Wrap

The following types of wrapping material are recommended for use with EOGas 4:

Heat sealed packaging such as Tyvek® I Plastic.

Self seal pouches made of paper and film.

Cloth, paper, or Central Supply Room (CSR) wrap.

Exposure indicators such as the Andersen AN85 or AN86 can be used to seal or label items. Indicators will change color in the presence of ethylene oxide gas, helping to later identify items that have been sterilized. However, these exposure indicators do not indicate sterility.

The Sterilization Setup

Selecting the Cycle Length

Choose the appropriate cycle for the load to be sterilized. The EOGas 4 sterilizer offers two different pre-set sterilization cycles:

30° C. 12 Hour sterilization exposure, 120 minute bag ventilation

30° C.-24 Hour sterilization exposure, 120 minute bag ventilation.

Warming Up the Sterilizer

Make sure the EOGas 4 is connected to power, and turn the sterilizer on by pressing the black power switch located on the back of the cabinet. The initial startup screen will appear.

The temperature setting can be switched between standard (50° C.) and room temperature (30° C.) modes using the setup menu. Once set, press the button to the right of START on the display screen to initiate the self-test.

Once the temperature is within the appropriate range, loading instructions are shown on the screen.

The Sterilization Cycle

Loading the Liner Bag and Sterilizer

Place agricultural material(s) to be disinfected into a sterilization liner bag. Ideally, a new sterilization bag is used with every batch, as even a tiny pinhole in a liner bag can allow gas to escape and cause cycle failure.

Insert appropriate controls such as a chemical integrator (Dosimeter) or a standard 10⁶ Bacillus atropheaus biological indicator into the least accessible part of the sterilization liner bag. Add a Humidichip to the Humiditube and place into the sterilization liner bag.

Remove one AN1004 EOGas cartridge from the Refill Kit. Remove the tape and safety trigger guard on the cartridge and place the cartridge on top of the wrapped items so it can easily be manipulated through the wall of the bag. Do not activate the cartridge at this time.

Insert the purge probe into the sterilization liner bag with the bobbin and quick release fitting at the open end. Place the black Velcro® strap around the sterilization liner bag and the bobbin of the purge probe, and pull it snug through its loop to completely close the sterilization liner bag. The strap must tightly secure the sterilization liner bag around the purge probe bobbin in order to keep gas from escaping.

Connect the quick release connector to the purge probe hose if it is not already connected.

The sterilization liner bag may be loaded and sealed away from the sterilizer cabinet and connected to the purge tube once the sterilizer has warmed up.

Starting the Cycle

With the loaded bag sealed and connected to the purge tube, press the PURGE button.

The sterilizer will purge air out of the sterilization liner bag for 1 minute 30 seconds until the display reads ‘00:00:00’. The sterilization liner bag should vacuum down as excess air is removed.

After the initial purge has been completed the display instructs the operator to activate the cartridge, close the door, and select the cycle length:

or

Activate the cartridge by pressing the trigger button on the cartridge through the wall of the closed liner bag. Make sure that the button is fully depressed.

Note: The EOGas 4 cartridge has the precise amount of EO needed to sterilize contents of the EOGas 4 sterilization bag.

Close the door.

Select the length of the sterilization cycle.

If a cycle time is not selected within 5 seconds after closing the door, a continuous alarm will sound to remind you to choose a cycle length.

After the cycle length is selected, the display counts down time remaining. The door will remain locked. It is important to not interrupt a cycle once the gas cartridge has been activated, so as to avoid leakage of the EO.

Additional Aeration

Throughout the entire cycle, the ventilation system is always running to prevent ethylene oxide gas from entering the room. At the end of the sterilization cycle the cabinet ventilation pump and the purge pump will run in 2 minute intervals, purging the liner bag and ventilating the cabinet. This purge cycle continues for 30 minutes for the 3 hour cycle, 1 hour for the 5 hour cycle, and 2 hours for the 12 or 24 hour cycle.

Once the purge cycle is complete, the sterilizer will continue to ventilate and purge the liner bag. A count-up timer will begin on the sterilizer display to keep track of this additional aeration time, and the sterilizer will reset only after the door is opened and the exit button is pressed. The temperature in the room should continue to remain at least 68° F. during the aeration period.

Gas absorbent items require additional aeration after the regular sterilization/purge cycle and before they can be removed and used. This extra aeration prevents chemical burns to living tissue or inhalation risk that can be caused by residual ethylene oxide absorbed during the sterilization cycle. AAMI guidelines state that product aeration should take place inside the sterilizer cabinet.

Aeration Guidelines

In one embodiment, the agricultural material remains in the EOGas sterilizer to aerate for an additional 4-24 hours after the sterilization and purge cycles are complete. Aeration time shall be established to reduce EO residual levels such that the processed products comply with relevant US EPA requirements.

Unloading the Sterilizer and Determining Sterility

Unloading the Liner Bag

Remove the sterilized agricultural materials only after the sterilization cycle, purge cycle, and any additional aeration have been completed and the display indicates “UNLOAD STERILIZER”. To unload the sterilization liner bag away from the sterilizer, simply detach the purge probe hose from the bag using the quick release connector.

Remove the sterilized agricultural materials and examine the dosimeter. Make sure the blue line has progressed up to or beyond the triangular mark.

Discard the sterilization bag, Humidichip, and used cartridge with ordinary trash. Incubate Biological Indicator if using one. Retain Humiditube to use again.

Press “EXIT” to end the cycle and return the sterilizer to the standby state. Switch the power button to off.

It is advisable to never remove items before the full sterilization and purge cycles have completed. The purge cycle is designed to aerate most products sufficiently to avoid operator exposure to EOGas and to meet the OSHA short-term exposure level (STEL) of 5.0 ppm over 15 minutes.

Important Notes About Indicators

Biological Indicators (BI's) such as the AN 2203 EZ Test or use live spores and are the best confirmation of the success or failure of a sterilization cycle. Always follow manufacturer's recommendations when using B1s.

Chemical exposure integrators such as the AN87 Dosimeter provide immediate visual confirmation that time, temperature, and EOGas concentration were sufficient for sterilization to occur.

Chemical exposure indicators such as the AN85 or AN86, do not prove sterilization. They only change color to show that the items have been exposed to ethylene oxide.

It is advisable to refer to manufacturer's instructions when using sterility or exposure indicators.

Safety Precautions

Ethylene Oxide Safety

Do not allow open flame or sparks near the sterilizer during the sterilization cycle. Ethylene oxide gas is highly flammable in concentrations above 3.0% (30,000 ppm).

Never interrupt a cycle in progress. Two consequences of removing and opening the EOGas bag before the cycle is complete are that the load might not be sterile and the bag may still contain high levels of EOGas and put the operator at risk of unsafe exposure

Sterilization liner bags should never be reused because they may have a puncture or tear.

Each sterilization cycle ends with a purge cycle that flushes fresh air around the items in the load. Purge time shall be established to reduce EO residual levels such that the processed products comply with relevant US EPA requirements.

Personnel exposure to ethylene oxide can be monitored by using personal exposure badges such as the Andersen AN93 AirScan® Badges. The AN93 AirScan Kit has both STEL (15 min.) and TWA (8 hour) badges. EO exposure levels should be checked upon installation of the sterilizer. We recommend that exposure testing be performed on an annual basis or whenever a sterilizer is relocated. OSHA guidelines for personal monitoring can be found at www.cdc.gov/nioshlprograms/ppt.

If a cartridge is accidentally activated outside of the liner bag, immediately place it in the Zip-Lock Safety Bag and connect the quick connect fitting to the input on the upper left side of the sterilizer. Ensure the sterilizer's ventilation pump is running.

Either a material safety data sheet (MSDS) or analogous safety information shall be made available for EO and its diluents (if any). Measures necessary to protect the health and safety of personnel shall be identified.

The potential effect on the environment of the operation of the sterilization process shall be assessed, and measures to protect the environment shall be identified in accordance with State and local regulations. This assessment, including potential impact and measures for control, shall be documented.

### Example 2: Description of Andersen Anprolene Room Temperature Decontamination Process

Liquid ethylene oxide (EO) converts to gas at 10.4° C. In its gaseous state it becomes an effective decontaminant around 15-20° C. This physical property of EO is the basis for the Andersen Anprolene system, a process that has been used for medical device sterilization since the 1960's. The original Anprolene system (provided by Andersen Products, Haw River, N.C.) has been recognized by the US Food and Drug Administration as a “pre-amendment device”, and the latest version of the system received FDA clearance in 2015. Anprolene (EO) gas ampoules have been registered with US EPA since 1971.

Process Description

The Anprolene system works using a plastic sterilization bag which is filled with the items to be sterilized. A glass ampoule of EO, which is packaged in a sealed polyethylene Gas Release Bag, is added to the sterilization bag with appropriate sterility indicators (biological indicators and/or chemical exposure indicators).

A purge probe is inserted into the open end of the bag and drawing a Velcro strap firmly around the neck of the probe then seals the mouth of the bag. The bag and purge probe are then placed inside the sterilizer cabinet and the purge probe is connected to the cabinet by means of a quick disconnect fitting and vacuum line. At the start of the cycle air is removed from the sterilization bag via the Purge Probe. The ampoule is then manually broken, and the sterilization process begins. The liquid EO in the ampoule converts to gas and fills the Gas Release Bag. EO diffuses out of the gas release bag into the sterilization bag, which sterilizes the products inside.

During the process the sterilization cabinet acts as an enclosed vent hood, maintaining a continuous air flow around the sterilization bag. The ventilation system maintains a modest sub-atmospheric pressure in the cabinet. Air drawn through the cabinet is continuously evacuated to the outside by means of an exhaust hose.

In some embodiments, the cabinet does not use supplemental heaters or chillers, and operates at the temperature of the room where it is installed. In such embodiments, for effective processing the temperature in the sterilization room must be maintained above about 15° C., and below about 30° C., throughout the course of the cycle.

At the end of the cycle the Purge Probe removes EO from the sterilization bag and initiates a purge process that flushes clean air through the bag for two hours. At the end of this purge process the cabinet enters aeration mode, during which it continues to flush the sterilization bag with clean air and keeps track of elapsed aeration time.

Aeration of Processed Agricultural Materials

In the Anprolene system sterilization and aeration take place in the same cabinet. Treated agricultural materials are not removed from the sterilization bag and cabinet until they are fully aerated and safe to handle.

Process Controls

The Anprolene process has a full range of process controls that are designed to work with the system.
Chemical Indicators—the AN85 Exposure Indicator Strip allows operators to quickly identify which loads have been sterilized and which have not. The indicator strips change from yellow to blue when sterilization has occurred. These indicators react to exposure to EO. They do not confirm sterility.
Dosimeter™ Chemical Integrators—The AN87 Dosimeter confirms that the conditions for sterilization have been met and provides an immediate feedback on the success of a sterilization cycle. The AN87 meets the criteria for an ISO Class V integrator and have 510(k) clearance from US FDA.
Biological Indicator—The Anprolene system is compatible with standard 10⁶ Bacillus atrophaeus indicators that have been cleared for use with EO processes. Biological indicators require 48 hours of incubation after having been processed to confirm results.

Accessories: Emissions Abatement

Andersen Anprolene sterilizers use only 17.5 grams of EO per cycle. This small quantity of EO is released at the end of a 12-hour cycle, which results in a very low concentration of gas in the exhaust stream. The very low concentration of EO in the Anprolene system exhaust allows for the use of a simple technology to abate the gas. Anprolene abators employ a dry cationic resin bed that chemically converts the ethylene oxide into an inert polymer. The only component of this system with moving parts is the exhaust blower. Since the exhaust blower pulls the exhaust through the resin bed, only “clean” air reaches the blower. There is no possible ignition source in the exhaust line.

The Andersen 5100 Abator uses a disposable resin cartridge that can absorb the gas from 200 sterilization cycles before it needs to be replaced.

### Example 3: Barrel-Sized Sterilization Equipment

Summary of Results Preliminary Testing of Microbial Decontamination Barrel

Introduction:

In cases of hazardous microbial contamination of agricultural products in amounts too large to disinfect in the sterilization bags discussed elsewhere herein, a larger sterilization device can be used. This example establishes that material can be disinfected/sterilized in a standard 55-gallon drum with very low concentrations of ethylene oxide (<100 mg/L) at room temperature (around 20° C.).

Background

It has long been established that items can be effectively sterilized with ethylene oxide (EO) in a variety of improvised containers. In the 1960's H. W. Andersen, MD, patented and sold an EO sterilization system that operated at ambient temperature and with no external power source. This system employed polyethylene sterilization bags and unit dose ampoules of EO.

Theory

It is recognized that there is a negative linear relationship between ethylene oxide (EO) concentration and sterilization time.

Recent studies have demonstrated that EO lethality is linear with respect to concentration at levels from 1200 mg/L down to as low as 8 mg/L.

EO has a LEL of 3%. EO concentrations below this limit are still anti-microbial without the potential flammability of traditional EO cycles.

At very low concentrations EO will exhibit longer D-Values, resulting in final cycle times measured in days instead of hours.

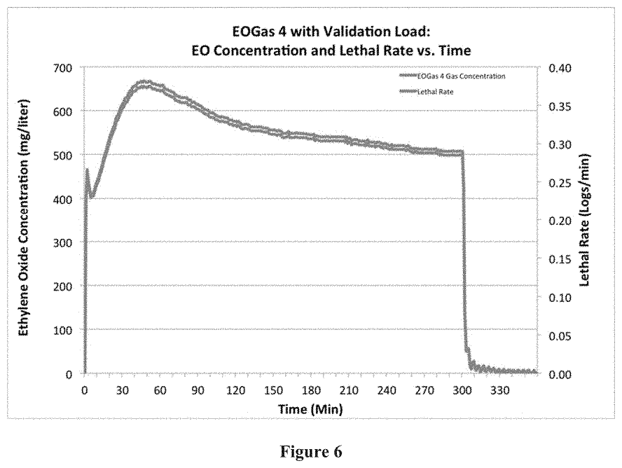

By way of example, FIG. 6 is a chart showing EO lethality in terms of concentration (mg/liter) and lethal rate (logs/min) over time (min).

Methods

Barrel Setup: All cycles were performed using a 48.8 gallon steel barrel with an airtight lid sealed with a rubber gasket.

Barrels were fitted with an SEC Sensor to monitor EO concentration throughout the cycle

The unit utilizes AN 7916 Anprolene gas release ampoules, which contain approximately 17.6 g of EO. The number of ampoules can be adjusted according to load weight.

Barrels were fitted with an observation chamber containing a chemical integrator, referred to a dosimeter. This allows sterilization progress to be monitored in real time with no disruption to the cycle.

An external recirculating abator cartridge was attached to the lid of the barrel to neutralize EO when the cycle is complete.

Empty Barrel Cycles: Load Configuration

Humidichips, a Madgetech Datalogger, and a Steritest biological indicator including a Dosimeter and a Bacillus atrophaeus spore strip, were placed in the bottom of the barrel. An AN 7916 EO 17.6 g ampule was activated then placed in the bottom of the barrel.

Paper Cycles; Load Configuration

Note: Extensive testing of metal, plastic, cloth and paper loads has indicated that paper loads present a particularly difficult challenge to EO sterilization. Further, paper represents a reasonable proxy for agricultural materials such as hemp and marijuana, as all of these materials are all cellulosic materials. Accordingly, a successful demonstration with paper demonstrates that the technique, and device, are applicable to decontamination of agricultural products.

In this example, the barrel was loaded with 150 lbs of paper. Humidichips, a Madgetech Datalogger, and a Steritest were placed in the middle of the load. The Barrel was filled to the top with cloth materials (which are also cellulosic materials). An AN 7916 EO ampoule was activated and placed at the top of the load.

Results

A total of seven 2-4 day cycles were run. All cycles successfully sterilized the Bacillus atrophaeus spore strips contained in the Steritest. All Dosimeter(s) from the cycles indicated that concentration and duration of ethylene oxide exposure was adequate for sterilization

Three cycles were run to establish the ethylene oxide concentration that can be maintained in an empty, airtight 48.8 gallon HDPE barrel. The average ethylene oxide concentration maintained in the empty barrel cycles was 70.3 mg/L.

Two cycles were run to establish the ethylene oxide concentration that can be maintained in a barrel filled with 150 pounds (equivalent to 30 reams) of paper. The average ethylene oxide concentration maintained in the paper cycles was 13.9 mg/L.

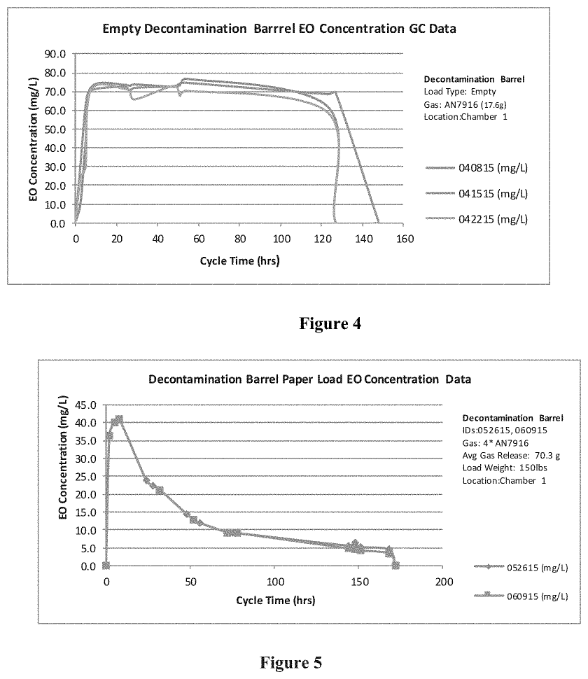

Results are shown in FIGS. 4 and 5. As shown in these figures, the ethylene oxide concentration was reduced to acceptable levels over time.

### CONCLUSIONS

Advantages: The microbial decontamination barrel was successful at maintaining ethylene oxide levels sufficient to kill 10⁶ biological surrogates (Bacillus atrophaeus) included with each load. Decontamination can be completed without electricity, a water source or vacuum.

This method of decontamination is inexpensive: all necessary components are disposable. The decontamination barrel does not require a lengthy installation or individual validation. This method is compatible with traditional process challenge devices including Bacillus atrophaeus biological spore strips and self-contained biological indicators. Further, the sterilization process is simple to learn and requires little training, and the relatively low concentration of ethylene oxide used in this method provides a modest risk profile.

One potential limitation of this device is that, due to the relatively low concentration of EO used in this method, relatively long cycle times (for example, 48-96 hours) may be required. Further, unless the barrel is stored indoors, it may be difficult for the user to ensure that the ambient temperature remains in the desired range of 15−30° C. throughout the cycle, in order to ensure proper sterilization without also damaging the agricultural material by converting a significant quantity of carboxylic acid groups to esters.

In one embodiment, the invention relates to the barrel disinfection device itself, whether or not used to disinfect contaminated agricultural material.

All publications, patents, and patent applications cited in this specification are incorporated herein by reference in their entirety, and for all purposes, as if each publication, patent, or patent application was specifically and individually put forth herein. All ASTM specifications recited herein are also incorporated by reference. Modifications and variations of the present invention will be obvious to those skilled in the art from the foregoing detailed description of the invention.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

1. A method of decontaminating a harvested agriculture crop of one or more bacterial or fungal microorganisms, comprising contacting the agricultural crop with ethylene oxide at a temperature between about 15 and about 30° C. for a sufficient time, and at a sufficient pressure, to decontaminate the agricultural crop.

2. The method of claim 1, wherein the crop comprises hemp and/or marijuana.

3. The method of claim 1, wherein the pressure is between around 0.8 and 1.2 atmospheres of pressure.

4. The method of claim 1, wherein the contact time is between about 3 and about 98 hours.

5. The method of claim 1, wherein the crop and the ethylene oxide are placed in a container during the decontamination process.

6. The method of claim 1, wherein the container is a sealable, gas permeable bag sized to hold up to 5 pounds of the crop.

7. The method of claim 1, wherein the container is a sealable, gas impermeable bag sized to hold up to 5 pounds of the crop.

8. The method of claim 1, wherein the container is a sealable drum of a size up to 55 gallons.

9. The method of claim 1, wherein the container is a pallet-loaded sterilization container.

10. A method of decontaminating a harvested agriculture crop of one or more bacterial or fungal microorganisms, comprising:
a) Placing a harvested agricultural crop to be decontaminated, and an ampoule containing ethylene oxide, which ampule is adapted such that it can be opened while present in a sealed bag, in a plastic sterilization bag,
wherein the plastic sterilization bag comprises an open end and a closed end, and is of a sufficient size to encompass the agricultural product to be decontaminated, and
wherein the plastic sterilization bag further comprises a system for sealing the agricultural product in the bag, while inhibiting release of ethylene oxide to be released from the ampule,
b) opening the ampoule to release the ethylene oxide within the bag, and
c) contacting the harvested agricultural crop with the ethylene oxide at a temperature between about 15 and about 30° C. for a sufficient time, and at a sufficient pressure, to decontaminate the agricultural crop.

11. The method of claim 10, further comprising purging unreacted ethylene oxide, if present, from the bag.

12. The method of claim 10, wherein the unreacted ethylene oxide is purged using an inert gas.

13. The method of claim 10, wherein the inert gas comprising unreacted ethylene oxide is passed over an acidic or basic material, which neutralizes the ethylene oxide.

14. The method of claim 13, wherein the acidic material is a Dowex sulfonic acid resin.

15. The method of claim 10, wherein the plastic bag is a gas-permeable bag.

16. The method of claim 10, wherein the plastic bag is a gas-impermeable bag.

17. The method of claim 10, wherein unreacted ethylene oxide is purged via tubing connected to an external pump which draws the ethylene oxide through a dry cationic resin bed, which chemically converts the ethylene oxide into an inert polymer.

18. The method of claim 11, wherein the unreacted ethylene oxide is purged through a series of two or more cycles.

19. A system for decontaminating harvested agricultural crops, comprising:
a) a low density polyethylene decontamination bag comprising an open end and a closed end,
b) a ventilated rigid container adapted to receive said decontamination bag,
c) a means for temporarily sealing the open end of said bag, and
d) one or more ampoules of liquid/gas ethylene oxide.

20. The system of claim 19, wherein agricultural products to be decontaminated are present within the bag.

21. A system for decontaminating harvested agricultural crops, comprising:
a) a decontamination bag of coextruded polyethylene and nylon film, comprising an open end and a closed end,
b) a ventilated rigid container adapted to receive said decontamination bag;
c) a tube,
c) a means for temporarily sealing the open end of said bag around said tube,
d) a means for creating a temporary vacuum in said bag,
e) a method for releasing ethylene oxide gas within said bag, and
f) a means for purging gases said bag.
